(19) United States
(12) Patent Application Publication
(10) Pub. No.: US 2001/0045153 A1
(43) Pub. Date: Nov. 29, 2001

(54) Apparatus for detecting the fundamental frequencies present in polyphonic music

(75) Inventors: John S. Alexander, Voorhees, NJ (US); Kristopher A. Daniel, Philadelphia, PA (US); Themis G. Katsianos, Longmont, CO (US)

Correspondence Address: AKIN, GUMP, STRAUSS, HAUER & FELD, L.L.P., ONE COMMERCE SQUARE, 2005 MARKET STREET, SUITE 2200, PHILADELPHIA, PA, 19103, US

(73) Assignee: Lyrrus Inc. d/b/a GVOX

(21) Appl. No.: 09/797,893

(22) Filed: Mar. 2, 2001

Related U.S. Application Data
(60) Provisional application No. 60/188,057, filed on Mar. 9, 2000.

(51) Int. Cl. G10H 7/00

(52) U.S. Cl. 84/609; 84/622

(57) ABSTRACT

A method for determining a fundamental frequency of a note in a musical signal comprising the steps of receiving the musical signal; determining a frequency of each of a plurality of tracks of the musical signal; generating a plurality of subharmonics for each track; and computing the fundamental frequency based on a frequency of at least one subharmonic selected from the plurality of subharmonics, the frequency of the at least one selected subharmonic being within a neighborhood of the frequency of the track having a lowest frequency.

### CROSS REFERENCE TO RELATED APPLICATIONS

This application claims the benefit of U.S. Provisional Application No. 60/188,057, filed Mar. 9, 2000, entitled “Polyphonic Pitch Detecting Method”.

### BACKGROUND OF THE INVENTION

The present invention relates to a method and apparatus for analyzing audio signals, and more particularly, to a method and apparatus for determining the fundamental frequencies present in a polyphonic musical signal.

Many persons, including musicians, own or have access to a personal computer. Further, many musicians have a need for transcribing a musical score or for comparing the performance of a musical score with the transcribed score.

An apparatus, such as a personal computer, capable of detecting the notes of a live musical performance would be useful for rendering the notes of the performance into a score or for comparison of the notes with the notes of an existing score.

The sound generated by a musical instrument frequently comprises a plurality of simultaneously sounded notes, i.e. a chord. Music comprising a plurality of simultaneous notes is referred to as polyphonic music, whereas music comprising only a single note at a time, such as vocal music, is referred to as monophonic music. Regardless of whether the music is polyphonic or monophonic, the sound wave produced by a note generally comprises a plurality of harmonically related frequencies (harmonics), the harmonic of the note having the lowest frequency being called the fundamental frequency of the sound wave.

It is well known that a musical sound can be synthesized for a particular musical instrument or vocalist if the frequency, amplitude and time boundaries of the fundamental frequency component(s) of the musical sound can be determined. However, it is a non-trivial problem to isolate and measure the actual frequency, amplitude and the time boundaries of the fundamental frequency component(s) because of the harmonic characteristic of the musical sound wave. The problem is further exacerbated when a chord is sounded, because there is a plurality of fundamental frequencies to be determined and the harmonics of the fundamental frequencies are generally interleaved. The complexity of a polyphonic musical signal is clearly shown in FIGS. 1 and 2 in which FIG. 1 shows a time domain representation of a four note chord comprising the notes C3, E3, G3 and C4, and FIG. 2. shows a frequency domain representation of the same chord. In addition to the innate complexity of a polyphonic signal, a chord may be characterized by notes which are harmonically related, i.e. C below middle C and middle C, as depicted in FIGS. 1 and 2. In this case all of the harmonics of the fundamental frequency of the higher note are masked by the harmonics of the lower note. The process for detection of the fundamental frequencies of the aforementioned type of chord is referred to in this application as the “inside note” detection process.

Some of the problems and the drawbacks of various approaches for detecting the fundamental frequencies characteristic of polyphonic music are cited in U.S. Pat. No. 6,140,568 which is hereby incorporated by reference and need not be repeated here. Accordingly, there is a need for a method, suitable for execution in a personal computer, for reliably detecting the fundamental frequencies present in polyphonic music. It is well known that fast Fourier transform (FFT) techniques are the most efficient means for determining the spectral composition of a complex waveform where there is no a priori knowledge of the spectrum of the complex waveform. However, it is categorically stated in U.S. Pat. No. 6,140,568 that the FFT is not a practical technique for extracting the fundamental frequencies of the musical signal in a personal computer because of the necessity for performing the extraction process with an FFT having an integration period that is a multiple of the aggregate wavelength of the sound wave, creating unrealistically massive demands on system resources.

The present invention overcomes the problems of the prior art by utilizing a combination of short period FFT processing and computationally efficient time domain processing to extract the fundamental frequencies of the musical sound wave, thereby eliminating the need to perform an FFT having an integration period that is a multiple of the aggregate wavelength of the sound wave and in so doing making it feasible to utilize a personal computer for detecting the fundamental frequencies of a polyphonic musical signal.

### BRIEF SUMMARY OF THE INVENTION

Briefly stated, the present invention comprises a method for determining a fundamental frequency of a note in a musical signal comprising the steps of receiving the musical signal; determining a frequency of each of a plurality of tracks of the musical signal; generating a plurality of subharmonics for each track; and computing the fundamental frequency of the note based on a frequency of one or more subharmonics selected from the plurality of subharmonics, where the frequency of the selected subharmonic(s) are within a neighborhood of the frequency of the track having a lowest frequency.

The present invention includes a further method for determining a fundamental frequency of a note in a musical signal. The method comprises the steps of receiving the musical signal; determining a frequency of each of a plurality of tracks of the musical signal; classifying each track to one and only one of a plurality of centroids, where each centroid is characterized by a frequency; updating the frequency of each one of the centroids based on an average of the frequency of each track classified to the respective centroid and a frequency of one or more subharmonics of each centroid for which the frequency of one or more of the subharmonics falls within a neighborhood of the respective centroid; and merging the plurality of centroids such that a remaining centroid represents the fundamental frequency of the note.

The present invention also includes a method for detecting the presence of an inside note comprising the steps of creating a list of a plurality of docket entries meeting a predetermined criteria in which each docket entry represents a separate note; applying each docket entry to a previously trained neural network; and outputting a signal for each docket entry proportional to a probability of the docket entry being a note having a fundamental frequency within a neighborhood of a harmonic of a different note.

The present invention also includes a computer readable medium on which is stored a computer executable program code for determining at one or more fundamental frequencies of a musical signal. The program comprises code for receiving a musical signal; code for determining a frequency of each of a plurality of tracks in the musical signal; code for generating a plurality of subharmonics for each track; and code for computing one or more fundamental frequencies based one or more subharmonics selected from the plurality of subharmonics where a frequency of the selected subharmonics are within a neighborhood of the frequency of the track having a lowest frequency.

The present invention also includes a programmed computer for determining a fundamental frequency of a musical signal. The computer comprises an input device for receiving a musical signal and for converting the musical signal into a digital signal; a storage device having a portion for storing computer executable program code; a processor for receiving the digital signal and the computer program, where the computer program operates on the digital signal to determine a frequency of each of a plurality of tracks in the musical signal to generate a plurality of subharmonics for each track and computes the fundamental frequency based on a frequency of one or more subharmonics selected from the plurality of subharmonics and a frequency of the track having a lowest frequency; and an output device for outputting the at least one fundamental frequency.

### BRIEF DESCRIPTION OF THE SEVERAL VIEWS OF THE DRAWINGS

The foregoing summary as well as the following detailed description of preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a time domain representation of a four note chord comprising notes C3, E3, G3 and C4;

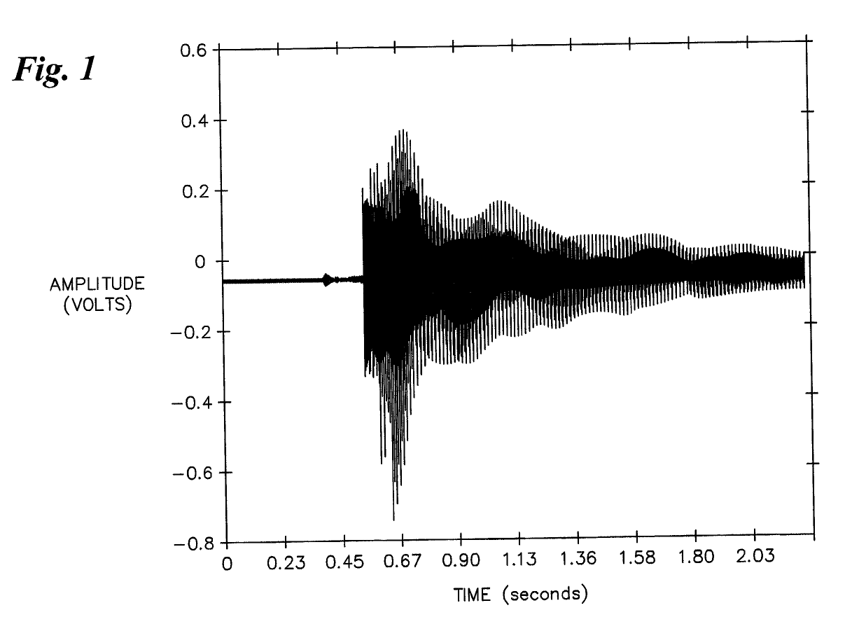

FIG. 2 is a frequency domain representation of the chord shown in FIG. 1, illustrating a plurality of tracks formed from a spectral analysis of the four note chord;

FIG. 3 is a functional block diagram of an apparatus for detecting the fundamental frequencies present in a polyphonic musical signal in accordance with a preferred embodiment of the present invention;

FIG. 4 is a flow diagram of a method for determining the fundamental frequencies present in the polyphonic musical signal in accordance with a first preferred embodiment of the present invention;

FIG. 5 is a flow diagram of the steps for generating the plurality of tracks in accordance with the first preferred embodiment of the present invention;

FIG. 6 is a flow diagram depicting the steps for associating a spectral peak with one of the plurality of tracks in accordance with the first preferred embodiment of the present invention;

FIG. 7 is a flow diagram of the steps for updating a frequency of each of the tracks in accordance with the first preferred embodiment of the present invention;

FIG. 8 is a flow diagram of the steps for clustering the plurality of tracks in accordance with the first preferred embodiment of the present invention;

FIG. 9A is a flow diagram of the steps for classifying/reclassifying the plurality of tracks in accordance with the first preferred embodiment of the present invention;

FIG. 9B is a continuation of FIG. 9A;

FIG. 10 is frequency domain depiction of the notes of FIG. 2, showing the plurality of tracks and the initial assignment of a centroid to each of the plurality of tracks in accordance with the first preferred embodiment of the present invention;

FIG. 11 is a flow diagram of the steps for updating a time and a frequency of each of the centroids in accordance with the first preferred embodiment of the present invention;

FIG. 12 is a detailed flow diagram of the steps for updating the frequency of each of the centroids in accordance with the first preferred embodiment of the present invention;

FIG. 13A is a flow diagram of the steps for merging the centroids in accordance with the first preferred embodiment of the present invention;

FIG. 13B is a continuation of FIG. 13A;

FIG. 14 is a frequency domain depiction of the tracks of FIG. 2 showing the reclassification of the tracks to the centroids after a first iteration of a classification/reclassification loop;

FIG. 15 is a frequency domain depiction of the tracks of FIG. 2 showing the reclassification of the tracks to the centroids after a second iteration of the classification/reclassification loop;

FIG. 16 is a flow diagram of the steps for detecting an inside note in accordance with the first preferred embodiment of the present invention;

FIG. 17 is a flow diagram of the steps for computing the probability of a potential note being an inside note in accordance with the first preferred embodiment of the present invention;

FIG. 18 is a schematic block diagram of a neural network in accordance with the first preferred embodiment of the present invention;

FIG. 19 is a frequency domain depiction of the tracks of FIG. 2 showing the final determination of a start time, a stop time and a fundamental frequency of each of the notes comprising the four note chord after processing by the neural network;

FIG. 20 is a flow diagram of the steps for generating the plurality of tracks according to the second preferred embodiment of the present invention; and

FIG. 21 is a flow diagram of the steps for clustering the plurality of tracks according to the second preferred embodiment of the present invention.

### DETAILED DESCRIPTION OF THE INVENTION

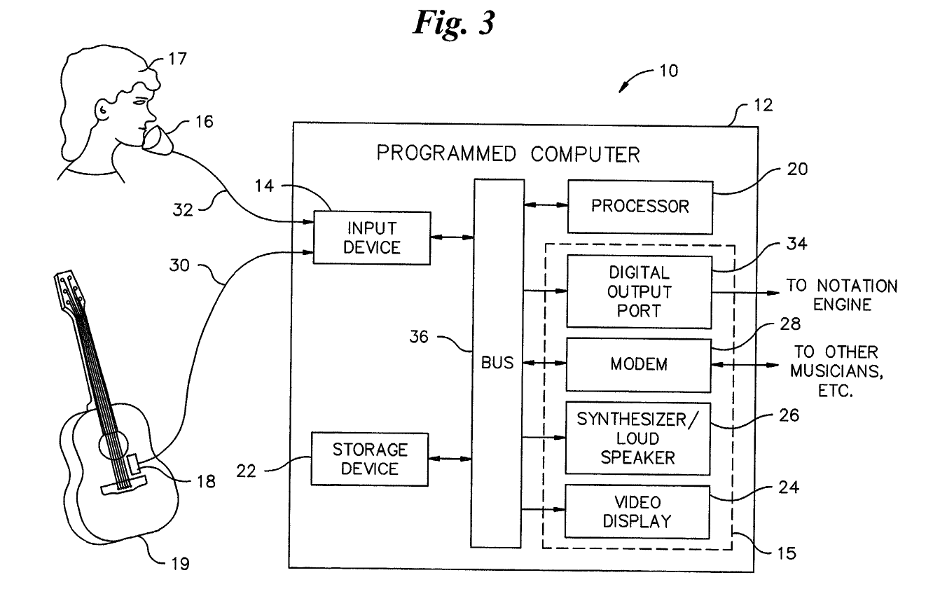

Referring to the drawings, wherein like numerals are used to indicate like elements throughout the several figures and the use of the indefinite article “a” may indicate a quantity of one or more than one of an element, there is shown in FIG. 3 a block diagram of an apparatus 10 for detecting a single note of a monophonic musical signal and multiple simultaneous notes of a polyphonic musical signal according to a preferred embodiment of the present invention. The apparatus 10 includes a programmed computer 12 comprising an input device 14 for receiving a representation of the musical signal, a storage device 22 having a portion for storing a computer executable program code (computer program), a processor 20 for executing the computer program stored in the storage device 22 and an output device 15 for outputting a signal representing the notes of the polyphonic musical signal, all of which are connected by a bus 36.

Desirably, the programmed computer 12 is a type of open architecture computer called a personal computer (PC). In the first preferred embodiment, the programmed computer 12 operates under the Windows® operating system manufactured by Microsoft® Corporation and employs a Pentium® III microprocessor chip manufactured by Intel® Corporation as the processor 20. However, as will be appreciated by those skilled in the art, other operating systems and microprocessor chips may be used. Further, it is not necessary to use a PC architecture. Other types of computers, such as the Apple® Macintosh® computer manufactured by Apple Inc., or a special purpose or other general purpose computer may be used within the spirit and scope of the invention.

In the first preferred embodiment, the input device 14 is operative with a microphone 16 for receiving electrical signals over a microphone input line 32 representative of the sound waves from a musical instrument such as a recorder, clarinet, saxophone, violin or a trumpet (not shown), or from the voice tract of a human 17. The input device 14 also accepts electrical signals representative of the vibrations of the strings of a guitar 19 from a transducer 18 shown attached to the guitar 19 over a transducer input line 30. Preferably, the input device 14 is a conventional sound card available from numerous vendors and adapted to conventional installation in the computer 12. Typically, the sound card provides an audio amplifier, bandpass filter and an analog-to-digital converter, each of a kind well known to those skilled in the art, for converting an analog electrical signal from the microphone 16 and the analog electrical signal from the transducer 18 into a digital audio signal compatible with the components of the programmed computer 12. In the first preferred embodiment, the analog microphone 16 and transducer 18 signals are sampled at a rate of 44.1 KHz., each sample being represented by a 16 bit word. Preferably, the digital audio signal is stored in 1024 word buffers in a portion of the storage device 22 in either a .WAV or a .AIFF format. As would be clear to those skilled in the art, the present invention is not limited to accepting the input signals from a transducer 18 or microphone 32 or to the aforementioned sample rate, buffer size or sample size and data format. Other devices for converting sound waves to electrical signals and other sample rates, sample sizes, buffer sizes and data formats could be used within the spirit and scope of the invention.

The programmed computer 12 also includes the storage device 22. Desirably, the storage device 22 includes a random access memory (RAM), a read only memory (ROM), and a hard disk memory connected within the programmed computer 12 in an architecture well known to those skilled in the art. In addition to storing the computer program, the storage device 22 also stores the information representing the notes in the musical signal. The computer 12 also includes a floppy disk drive and/or a CD-ROM drive for entering computer programs and other information into the programmed computer 12.

Preferably, the output device 15 includes a digital output port 34 for providing a digital output signal conforming to the Musical Interface Device Interface (MIDI) specification. Preferably, the MIDI output is provided to a device for transforming the MIDI signal into musical notation or alternatively, to a synthesizer, for reproducing the musical signal. The output device further includes a modem 28 for exchanging information with computers used by other musicians, instructors etc. The connection of the modem 28 to other musicians may be via a point-to-point telephone line, a local area network, the Internet etc. The output device 15 also includes a video display 24 where for instance, the notes played on a musical instrument or sung or stored in the storage device 22 could be displayed on, for instance, a musical staff; and a synthesizer/loudspeaker 26, for listening to the notes stored in the computer 12.

In the first preferred embodiment the executable program code for determining the fundamental frequencies of the musical signal is stored in the ROM. However, as will be appreciated by those skilled in the art, the program code could be stored on any computer readable medium such as the hard disk, a floppy disk or a CD-ROM and still be within the spirit and scope of the invention. Further, the computer program could be implemented as a driver that is accessed by the operating system and application software; as part of an application; as part of a browser plug-in; or as part of the operating system.

In the present invention, a track represents an ongoing frequency component of a note. The present invention provides a method for determining a fundamental frequency of a note in a musical signal wherein the method comprises receiving the musical signal, determining a frequency of each of a plurality of tracks in the musical signal, generating a plurality of subharmonics for each track, and computing the fundamental frequency based on the frequency of one or more subharmonics selected from the plurality of subharmonics, where the frequency of each of the selected subharmonics is within a neighborhood of the frequency of the track having the lowest frequency. The method also includes classifying each track to one and only one of a plurality of centroids where each centroid is characterized by a frequency, updating the frequency of each centroid based on an average of the frequency of each track classified to the respective centroid and a frequency of every subharmonic of each centroid whose frequency falls with a neighborhood of the frequency of the centroid, and merging the plurality of centroids such that at least one remaining centroid represents the frequency of the note.

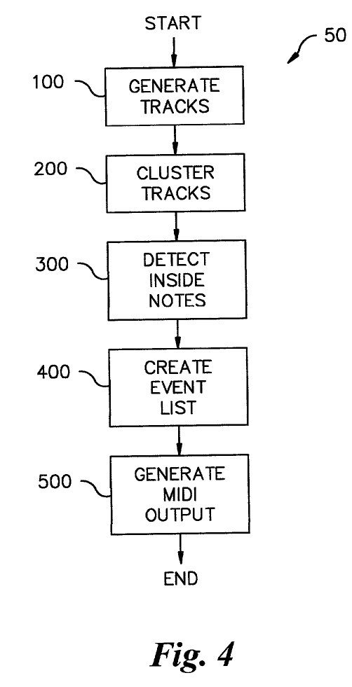

Referring now to FIG. 4 there is shown a method 50 for determining the fundamental frequencies present in a polyphonic musical signal received by the apparatus 10 according to the first preferred embodiment. The method 50 comprises the steps of generating tracks 100, clustering the tracks 200, detecting inside notes 300, creating an event list 400 and generating a MIDI output signal 500 representing the notes corresponding to the fundamental frequencies of the musical signal.

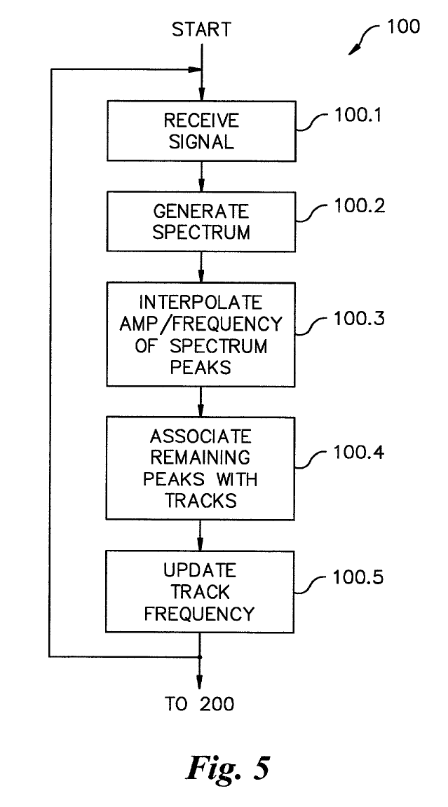

Referring now to FIG. 5 there is shown a more detailed flow diagram 100 for the steps of generating tracks. Preferably, the musical signal is received by the input device 14 (step 100.1) and is temporarily stored in the storage device 22 as buffers of 1024 samples of the digital audio signal. At step 100.2, each group of four buffers (4096 samples) of the digital audio signal is zero padded to 8192 samples and subjected to a fast Fourier transform (FFT) calculation of a type well known to those skilled in the art. Each spectral peak found in the FFT calculation having an amplitude relative to the noise floor greater than a predetermined value is interpolated (step 100.3) to provide greater amplitude and frequency accuracy. Preferably, the formulas for interpolating the peaks are:

amplitude of detected peak=i₁−0.25·K·(i₀−i₂) (1)

$$frequency of detected peak = \frac{{f}_{S}}{8192} \cdot ( n + K ) \qquad ( 2 )$$

where:

$$K = .5 \cdot \frac{{i}_{0} - {i}_{2}}{{i}_{0} - 2 \cdot {i}_{1} + {i}_{2}} \qquad ( 3 )$$

and:

i₁ is the magnitude of the detected peak, i₀ is the magnitude of the preceding peak, i₂ is the magnitude of the subsequent peak, n is the sample number of the detected peak and fs is the sample rate.

At step 100.4, each peak of the spectrum is associated with one and only one track. At a given point in time, the track is characterized as being ongoing, newly instantiated or terminated, based on the latest spectral measurement of the musical signal. A nearest neighbor rule (i.e. distance measure) is used to determine which track to associate with each peak.

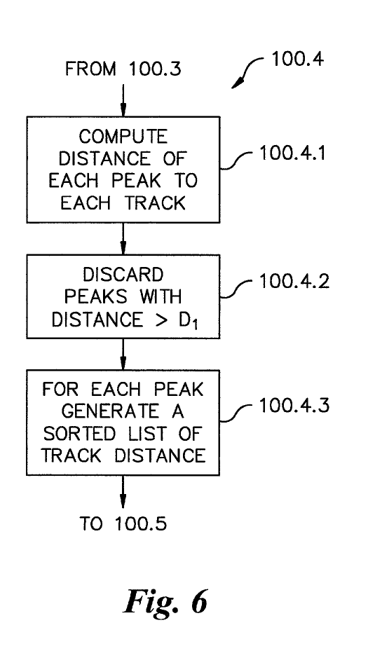

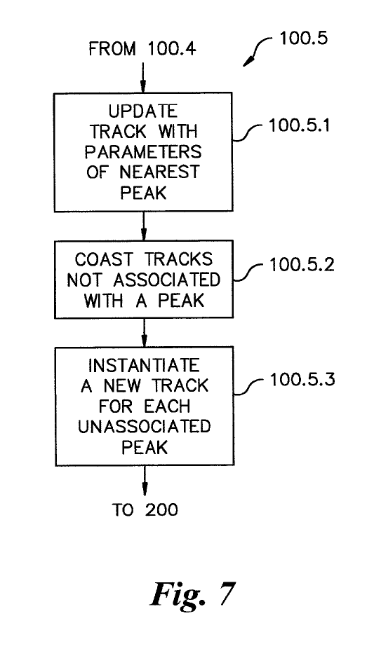

Step 100.4 is shown in greater detail in FIGS. 6 and 7. At step 100.4.1, each peak is initially compared to each ongoing track in accordance with the distance measure (see below). At step 100.4.2, peaks having distance greater than a predetermined distance value are discarded. A list of the distance between each track and each peak is created for each track, and sorted from the largest to the smallest distance (step 100.4.3). For each of the tracks, each peak having a distance less than a predetermined threshold is added to a list of matches for that track. The distance between each peak and each track in the list of matches is examined and the entry of the peak in the list of matches having the smallest distance measure (nearest neighbor rule) is retained in the list of matches. The frequency and the amplitude of each track is then updated (step 100.5.1) with the frequency and amplitude of the nearest peak. Tracks that associate to only an already associated peak are terminated. Tracks that don't associate with any peak are coasted, i.e., updated by a prediction computation (step 100.5.2). Peaks having a distance to any ongoing track greater than the predetermined threshold are used to instantiate a new track (step 100.5.3). In the first preferred embodiment the prediction of the track frequency and amplitude is calculated based on the well known Kalman prediction method (see for example, Blackman, S. S., Multiple-Target Tracking with Radar Applications, Artech House, Norwood, Mass. 1986, which is hereby incorporated in its entirety).

The first preferred embodiment uses the following model to predict the frequency and the amplitude of the coasting track:

x(k+1)=Φ·x(k)+u(k) (4)

y(k)=H·x(k)+w(k) (5)

In the above equations, x(k+1) describes the state vector of the track at point k+1, x(k) describes the state vector of the track at point k, y(k) is the observation vector of the system, Φ is the state transition matrix, H is the measurement matrix, u(k) describes a zero-mean, white, Gaussian noise, and w(k) is the data measurement noise.

In the first preferred embodiment, the state transition matrix is given by

$$Φ = [ \begin{matrix}1 & 1 & 0 & 0 \\ 0 & 1 & 0 & 0 \\ 0 & 0 & 1 & 1 \\ 0 & 0 & 0 & .99\end{matrix} ] , \qquad ( 6 )$$

the measurement matrix is given by

$$H = [ \begin{matrix}1 & 0 & 0 & 0 \\ 0 & 0 & 1 & 0\end{matrix} ] , \qquad ( 7 )$$

the covariance matrix Q of the Gaussian white noise u(k) is given by;

$$Q = [ \begin{matrix}1 & 0 & 0 & 0 \\ 0 & 1 & 0 & 0 \\ 0 & 0 & 1 & 0 \\ 0 & 0 & 0 & 1\end{matrix} ] , \qquad ( 8 )$$

the covariance of the measurement noise w(k) is given by

$$R = [ \begin{matrix}1 & 0 \\ 0 & 1\end{matrix} ] , \qquad ( 9 )$$

the state vector of the track x(k) is given by

$$X = [ \begin{matrix}Track Magnitude \\ Track Magnitude Rate of Change \\ Track Frequency \\ Track Frequency Rate of Change\end{matrix} ] , \qquad ( 10 )$$

and, the state vector of the observation of the track is given by

$$Y = [ \begin{matrix}Peak Magnitude \\ Peak Frequency\end{matrix} ] . \qquad ( 11 )$$

In the first preferred embodiment the calculation of the distance between each peak and each track (step 100.4.1) is also calculated based on the Kalman filter as follows:

Distance=Error^{T}·(H·Cov_{X}·H^{T}+R)⁻¹·Error (12)

where:

Error=Y−H·X (13)

and Y, H, R and X have the same meanings as above and Cov_{X} is the covariance of the state vector of the track.

Alternatively, the parameters of a track may be calculated based on the well known alpha-beta tracking algorithm, where the following equations are applied separately to the amplitude changes and the frequency changes of the track: (see Sterian, A. and Wakefield, G. H., “A Model Based Approach to Partial Tracking for Musical Transcription”, Presented at 1998 SPIE Annual Meeting San Diego, Calif., 1998).

xₚ(k+1)=x₅(k)+T·vₛ(k), (14)

xₛ(k)=xₚ(k)+α·(y(k)−xₚ(k)) (15)

$${v}_{S} ( k ) = {v}_{S} ( k - 1 ) + \frac{β}{q \cdot T} ( y ( k ) - {x}_{p} ( k ) ) , \qquad ( 16 )$$

where y(k) is the observation of the track amplitude or frequency at time k, T is the sampling interval (in this case, the amount of time between successive FFTs), α. and β are the fixed coefficient filter parameters, xₚ(k) is the output of the alpha-beta filter at the preceding time increment, and xₚ(k+1) is the alpha-beta filter's prediction of the object's location for the current time increment.

Alternatively, the distance is calculated by:

$$Distance = \sqrt{2 \cdot {( {Amp}_{Track} - {Amp}_{Peak} )}^{2} + {( 1200 \cdot {log}_{2} \frac{{Freq}_{Track}}{{Freq}_{Peak}} )}^{2}} , \qquad ( 17 )$$

where Amp_{track} is the average amplitude of a track, Amp_{Peak} is the amplitude of the spectral peak, Freq_{track} is the average frequency of the track and Freqₚₑₐₖ is the frequency of the spectral peak.

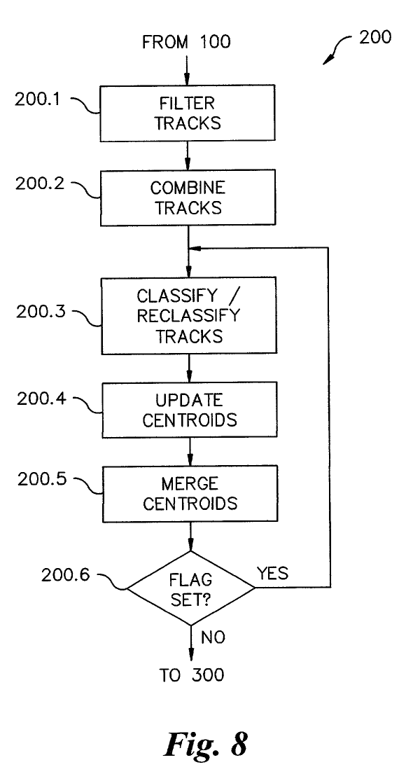

FIG. 8 discloses the steps for clustering the tracks. The process of clustering the tracks (step 200) includes filtering the tracks (step 200.1), combining the tracks (step 200.2), classifying/reclassifying the tracks to a centroid (step 200.3), updating parameters of the centroids (200.4), merging the centroids (step 200.5) and setting a change flag (step 200.6) if the classification of any tracks has been changed by the reclassification step.

Preferably, the step of filtering the tracks (step 200.1) includes: (1) discarding all the tracks that have a time duration of less than a predetermined value; (2) discarding all the tracks that have an amplitude less than a predetermined value; and (3) discarding all the tracks having a frequency less than a predetermined value. In the first preferred embodiment, tracks having a duration of less than two samples, a magnitude of less than 20 units and a frequency less than 40 Hz. are discarded.

The step of combining the tracks (step 200.2) examines each track to identify steady state portions of the track in order to identify restrikes and to eliminate processing of noisy attacks. The determination of whether a portion of a track is in steady state is determined from a calculation of the gradient of the track, where:

$$gradient = \sqrt{{( amp ( n + 1 ) - amp ( n ) )}^{2} + 1200 \cdot abs ( {log}_{2} \frac{freq ( n + 1 )}{freq ( n )} )} , \qquad ( 18 )$$

and where:

amp(n) refers to the amplitude of the nth sample, amp(n+1) refers to the amplitude of the n+1 sample, freq(n) refers to the frequency of the nth sample and freq(n+1) refers to the frequency of the n+1 sample.

Successive calculations of the gradient vector, each of length of 25 samples, using a step size of one sample are examined. If the maximum value of the gradient of a segment of a track is below a predetermined value, the segment is declared to be in the steady state. The end of a steady state portion is determined by examining successive gradient values. When a gradient value that is above the predetermined value is found, the end of the steady state portion of the track is marked with an end time. If there is at least one steady state associated with the track, the process is repeated to determine if there are more steady state portions of the track. For each steady state portion of each track, a start and an end time, a mean amplitude and a frequency, an amplitude integral, (the integral of the amplitude over the time span of the steady state portion), and a corresponding track number are stored.

Following the step of determining the steady state portions of each track (step 200.1), the steady state portions that are too short to stand by themselves and that also satisfy certain likeness criteria are combined (step 200.2). Each steady state portion, belonging to the same track number is examined. If, for two consecutive steady state portions: (1) the difference between the end time of the first steady state portion and the start time of the second steady state portion, is less than a predetermined threshold; (2) the duration of each of the consecutive steady state portions is less than a predetermined value; (3) the frequency difference between the consecutive steady state portions is less than a predetermined value; and (4) the amplitude difference between the consecutive steady state portions is less than a predetermined value, the consecutive steady state portions are combined into a new single steady state portion of the track. The new steady state portion has the start time of the first steady state portion and the end time of the second steady state portion. The frequency, amplitude, and amplitude integral of the combined steady state portion are determined to be a weighted average of the corresponding members of the two contributing steady state portions. The process of combining (step 200.2) the steady state portions of the selected track is repeated until the criteria for combining is satisfied. The process of combining like steady state portions is repeated for each track.

Following the combining of the steady state portions of each track, an iterative process (steps 200.3-200.6) is performed in which tracks are classified to a centroid (step 200.3), time and frequency estimates of each centroid are updated (step 200.4), centroids having similar parameters are merged (step 200.5) and a change in classification of a track due to updating the time and frequency is checked (step 200.6). In the iterative process (steps 200.3-200.6), each track is classified to one and only one centroid whereby a centroid member list of tracks is formed for each centroid. In forming each list of centroid member tracks, the tracks included in the centroid member list are constrained to have a frequency within a neighborhood of the centroid, or to have a frequency greater than the frequency of the centroid and to be within the neighborhood of a harmonic of the frequency of the centroid. Note that the term “neighborhood”, as used in the application, denotes a frequency difference between the (measured) frequency of the track and the frequency of a centroid or of a harmonic of the centroid that is so small, that it is clear that the track is a harmonic of the centroid and not of another centroid. The output of the iterative process (steps 200.3-200.6) is a list of centroids, each centroid being characterized by a (fundamental) frequency and a start time and representing a potential note. Associated with each centroid in the centroid list is the list of centroid member tracks, each centroid member track being characterized by a start time, an end time, an average frequency, a vector of the instantaneous frequency of the track over the track time interval, i.e. the interval between the start time and the end time, an average amplitude and a vector of the instantaneous amplitude of the track over the track time interval.

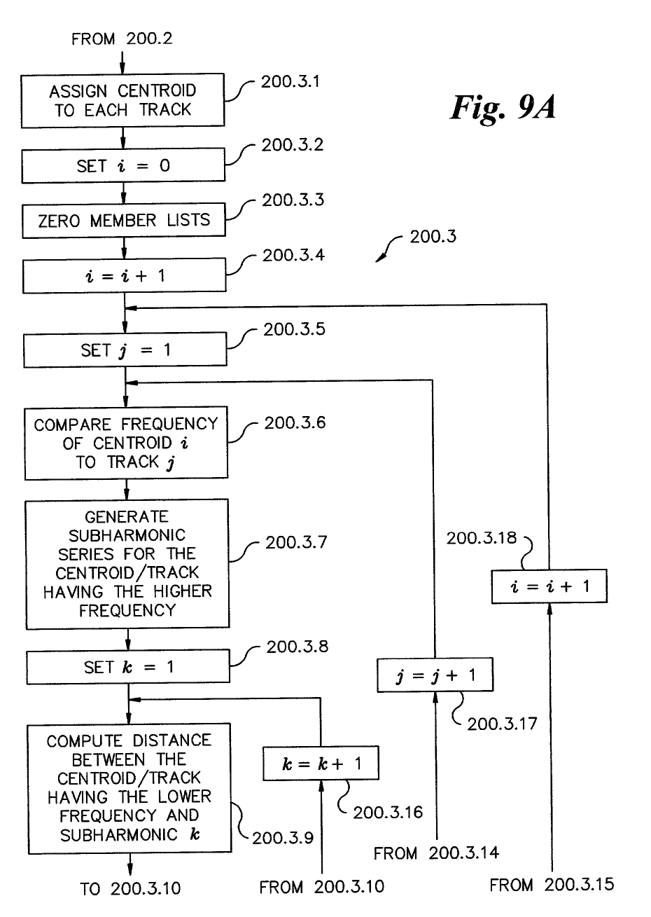

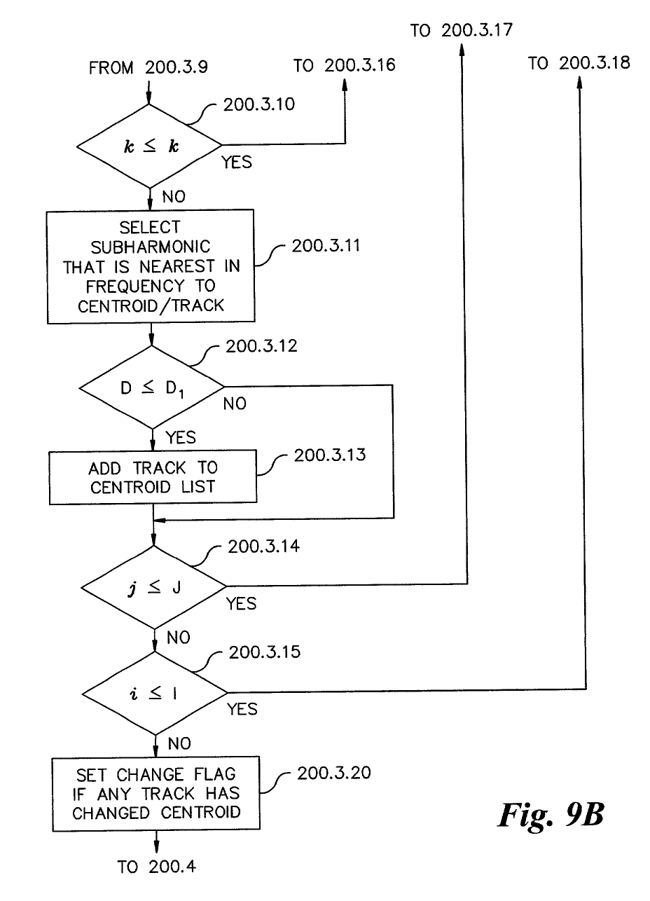

FIGS. 9A and 9B describe the details of classifying/reclassifying tracks (step 200.3) to a centroid. Each track is initially assigned a centroid having a value of the start time and the average frequency of the track (step 200.3.1). In steps 200.3.2-200.3.18 the distance is calculated between each subharmonic of the centroid/track having the higher frequency and the track/centroid having the lower frequency (step 200.3.9). The distance between the lower and the subharmonic of the upper is calculated as:

$$Distance = \sqrt{{( {Time}_{Track} - {Time}_{Centroid} )}^{2} + 100 \cdot {( 1200 \cdot {log}_{2} ( \frac{{freq}_{Track}}{{freq}_{Centroid}} ) )}^{2} ,} \qquad ( 19 )$$

where Time_{track} is the start time of a track, Time_{centroid} is the start time of a centroid, freq_{track} is the average frequency of a track and freq_{centroid} is the frequency of a centroid.

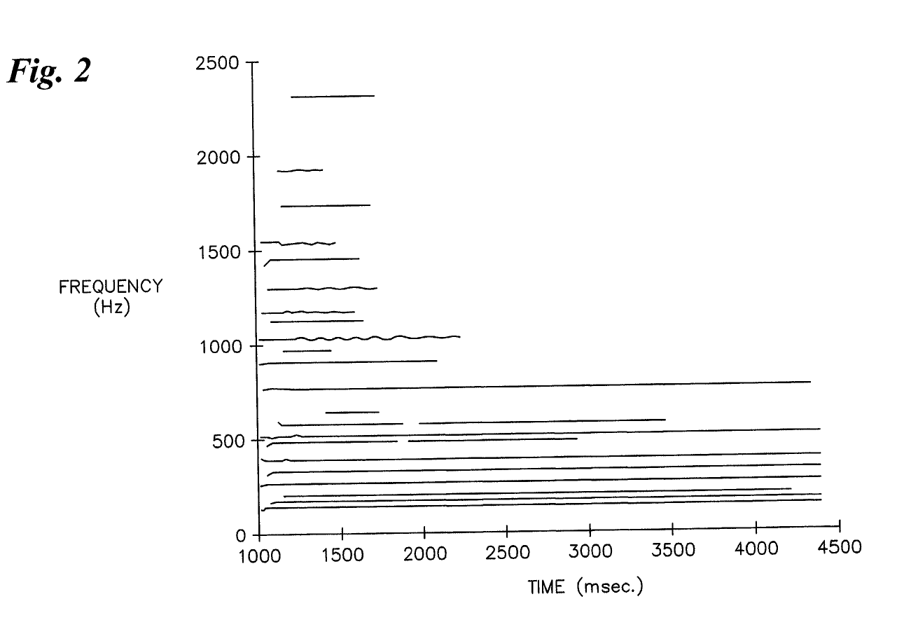

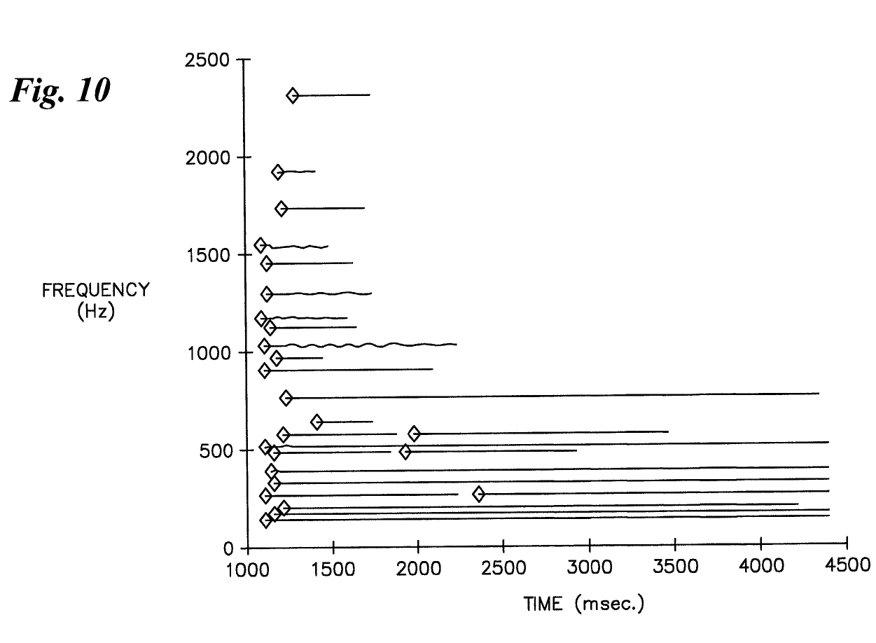

A track is classified to the centroid that is nearest to the track, i.e. having the minimum of the distances, provided that the minimum distance is less than a predetermined threshold. If the distance of a track to any centroid is greater than the predetermined threshold, the track is not classified to any centroid, and is not used for the centroidal update calculations (see step 200.4). At step 200.3.20, a change flag is set if any tracks have changed their centroid classification from a previous iteration of the classification/calculation. FIG. 10 illustrates, by a diamond figure, the assignment of a centroid to each of the tracks shown in FIG. 2 according to step 200.3.1.

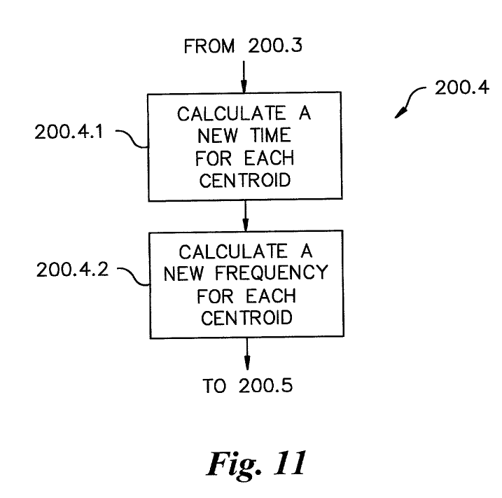

Referring now to FIG. 11, there is shown the steps for updating each centroid start time and frequency resulting from the reclassification of the tracks (step 200.4). At step 200.4.1, the start time of each centroid is adjusted by:

$$NewTime = \frac{1}{A} {\sum }_{j = 1}^{N} {Time}_{j} \cdot {AmplitudeIntegral}_{j} \qquad ( 20 )$$

$$A = {\sum }_{j = 1}^{N} {AmplitudeIntegral}_{j} \qquad ( 21 )$$

where:

N is the number of member tracks in the centroid member list and Time is the start time of each member track, j.

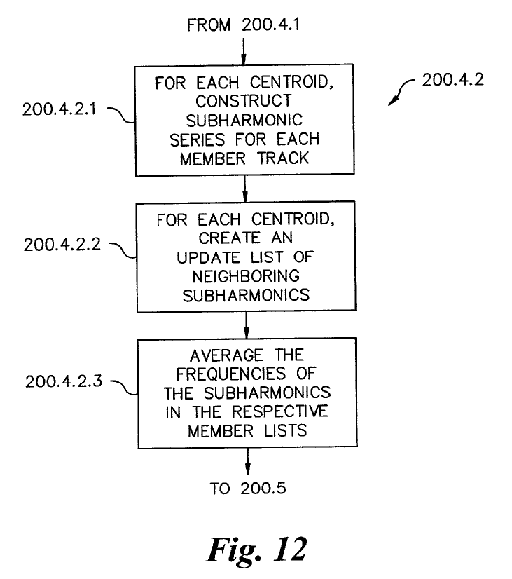

The frequency of each centroid is updated based on the frequencies of the member tracks of the centroid, and also the frequencies of the subharmonics of the member tracks of other centroids which fall within the neighborhood of the centroid frequency. Referring now to FIG. 12, there is shown the detail steps for updating the frequency of each centroid. At step 200.4.2.1, a subharmonic series is created and temporarily stored for each track in each centroid member list. The frequencies of the subharmonics in each subharmonic series is constrained to lay in a range from the frequency in the neighborhood of the respective centroid to a value greater than or equal to a frequency in the neighborhood of the lowest frequency centroid. At step 200.4.2.2, an update list is created for each centroid, wherein each update list comprises the subharmonic in each centroid member list which is nearest to the centroid frequency and lays within a neighborhood of the respective centroid frequency. At step 200.4.2.3, the frequencies of the subharmonics in each respective update list are averaged to provide an updated centroid frequency. In the first preferred embodiment, the average is a logarithmic average calculated as:

$$LogNewFrequency = \frac{1}{N} {\sum }_{j = 1}^{N} {log}_{2} ( update {freq}_{j} ) \qquad ( 22 )$$

$$NewFreq = {2}^{\frac{1}{N} {\sum }_{j = 1}^{N} {log}_{2} ( update {freq}_{j} )} \qquad ( 23 )$$

Following the updating of the start time and the frequency of each centroid, the centroids are merged (step 200.5). In the process of merging, pairs of centroids that meet a predetermined distance criteria (equation 17) are combined and the tracks in the member lists of the centroids are combined in the surviving centroid member list.

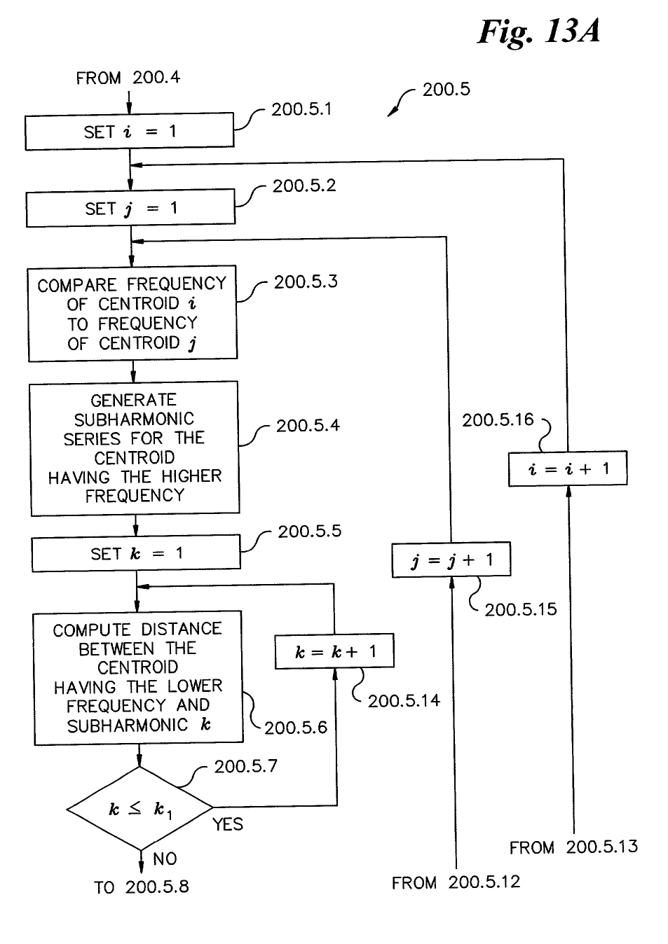

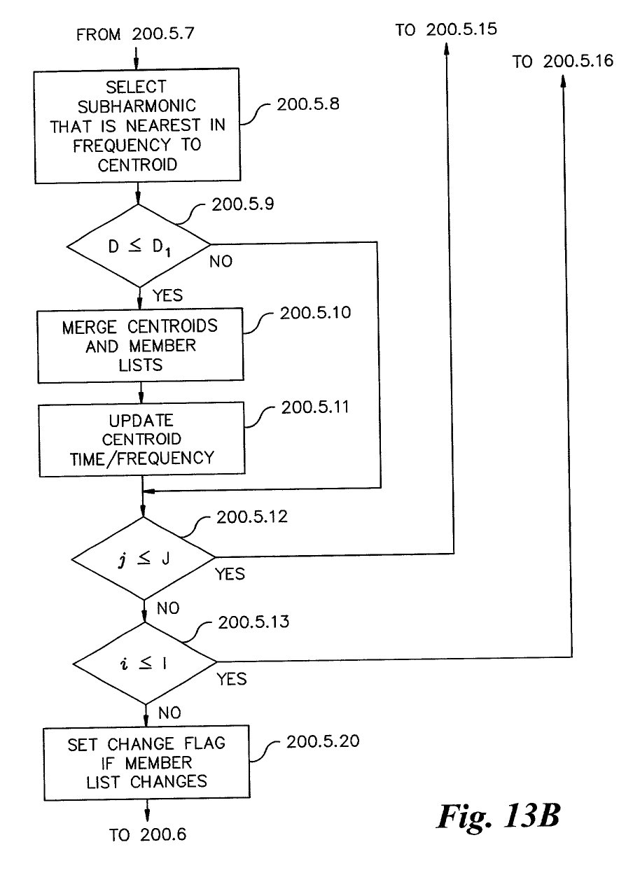

Steps 200.5.1 to 200.5.16, (FIGS. 13A and 13B) show the process of merging centroids. At step 200.5.3, the frequencies of each centroid pair are compared. At step 200.5.4, a subharmonic series is generated for the higher frequency centroid. At step 200.5.6 the distance is calculated between each subharmonic of the centroid i, having the higher frequency and the centroid j, having the lower frequency. The distance between each subharmonic of the centroid i and the centroid j is calculated as follows:

$${Distance}_{i , j} = \sqrt{{( {Time}_{Centi} - {Time}_{Centj} )}^{2} + 100 \cdot {( 1200 \cdot {log}_{2} ( \frac{{freq}_{sharmi}}{{freq}_{Centj}} ) )}^{2}} \qquad ( 24 )$$

where Time_{Centi} is the start time of centroid i, Time_{centj} is the start time of centroid j, freqₛₕₐᵣₘᵢ is the frequency of a subharmonic of centroid i and freq_{centj} is the frequency of centroid j.

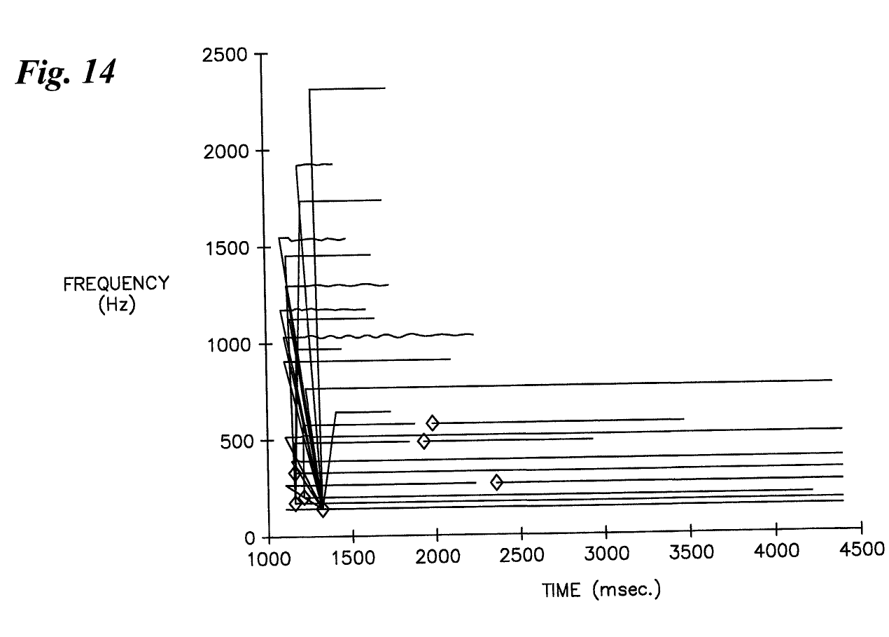

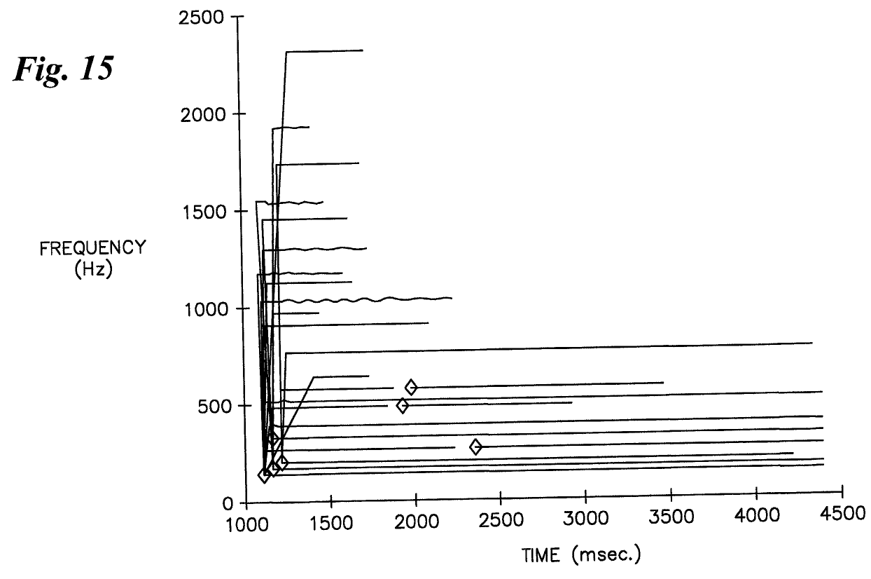

At steps 200.5.8-200.5.10, for each higher frequency centroid having a subharmonic within the neighborhood of the lower frequency centroid, the subharmonic having the minimum distance is added to the centroid member list of the lower frequency centroid and the higher frequency centroid is discarded. The frequency and time of the surviving centroids are updated according to equations 20 to 23. As in the process for classifying the tracks to a centroid, a change flag is set (step 200.5.20) if any change in a centroid member list occurs. The result of merging centroids is shown in FIGS. 14 and 15, where the initial set of centroids (FIG. 10) is reduced in number in the first iteration of clustering, FIG. 14, (step 200) and refined in frequency and start time in the second clustering iteration, FIG. 15, (step 200).

The steps of classifying (step 200.3), updating (200.4) and merging (step 200.5) continue until, at step 200.6, neither the track change flag (step 200.3.20) nor the member list change flag (step 200.5.20) is detected. The result of completing steps 200.1-200.6 is a list of potential notes.

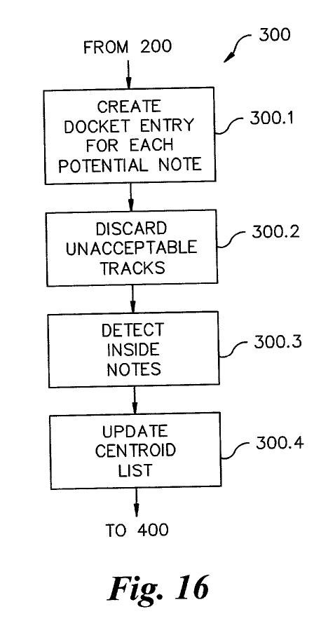

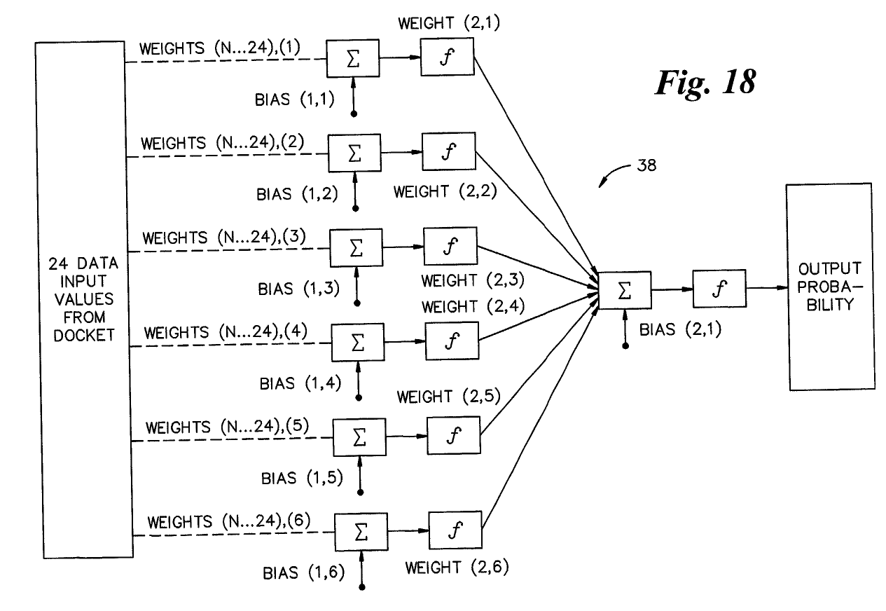

Referring now to FIGS. 4 and 16, the process of detecting one or more “inside notes” (step 300) is seen to comprise four major steps: (1) creating a docket entry in a docket for each potential note (step 300.1), (2) discarding potential notes not meeting a predetermined additional criteria (step 300.2), (3) applying the docket entries to a neural network 38 (see FIG. 18) and computing the probability of each potential note being an “inside note” (step 300.3), and updating the list centroids to correspond to the results of detecting the inside note(s). An “inside note”, as referred to herein, is a note having a fundamental frequency which is in the neighborhood of a harmonic of another simultaneously present note.

The initial step (step 300.1) of detecting an inside note is that of creating the docket comprising the docket entry for each potential note, i.e. centroid. Each docket entry comprises 24 elements as shown in Table I.

TABLE I

| Information | Harmonic Elements |
|---|---|
| Frequency | 0 |
| Difference | 1 |
| | 2 |
| | 3 |
| | 4 |
| | 5 |
| Magnitude | 0 |
| | 1 |
| | 2 |
| | 3 |
| | 4 |
| | 5 |
| Correlation Value 1 | (Frequency (Fundamental), amplitude harmonic 0) |
| | (Frequency (Fundamental), amplitude harmonic 1) |
| | (Frequency (Fundamental), amplitude harmonic 2) |
| | (Frequency (Fundamental), amplitude harmonic 3) |
| | (Frequency (Fundamental), amplitude harmonic 4) |
| | (Frequency (Fundamental), amplitude harmonic 5) |
| Correlation Value 2 | (Amplitude (Fundamental), amplitude harmonic 0) |
| | (Amplitude (Fundamental), amplitude harmonic 1) |
| | (Amplitude (Fundamental), amplitude harmonic 2) |
| | (Amplitude (Fundamental), amplitude harmonic 3) |
| | (Amplitude (Fundamental), amplitude harmonic 4) |
| | (Amplitude (Fundamental), amplitude harmonic 5) |

In Table I:

(1) Frequency difference, fd, is the amount by which the average frequency of a track in the centroid member list differs from the frequency of a corresponding harmonic of the centroid, i.e. the corresponding subharmonic being the subharmonic falling is within the neighborhood of the track. fd is computed as:

$$fd = 1200 \cdot abs ( {log}_{2} ( \frac{{f}_{hn}}{{f}_{actual}} ) ) \qquad ( 25 )$$

where fd equals frequency difference, fₕₙ equals the predicted frequency of harmonic h of the centroid, and f_{actual} equals the average frequency of the track assigned to harmonic h;

(2) Magnitude is the average magnitude of the track corresponding to harmonic h;

(3) Correlation Value 1 is the peak of the cross correlation between the frequency vector of the “0” harmonic track and the amplitude vector of the 0 to 5 harmonics of the track; and

(4) Correlation Value 2 is the peak of the cross correlation between the amplitude vector of the “0” harmonic track and the amplitude vector the 0 to 5 harmonic of the track.

At step 300.2, each docket entry is evaluated to determine if: (1) the docket entry contains at least 3 non-zero-magnitude tracks with total amplitude greater than a certain threshold, or (2) the docket entry contains one track which is the fundamental (harmonic 0) having an amplitude greater than a predetermined threshold, or (3) the docket entry contains two tracks that have a harmonic number difference less or equal to three, and a total amplitude greater than a predetermined threshold. If the docket entry fails to meet one of the aforementioned criteria, the docket entry is discarded.

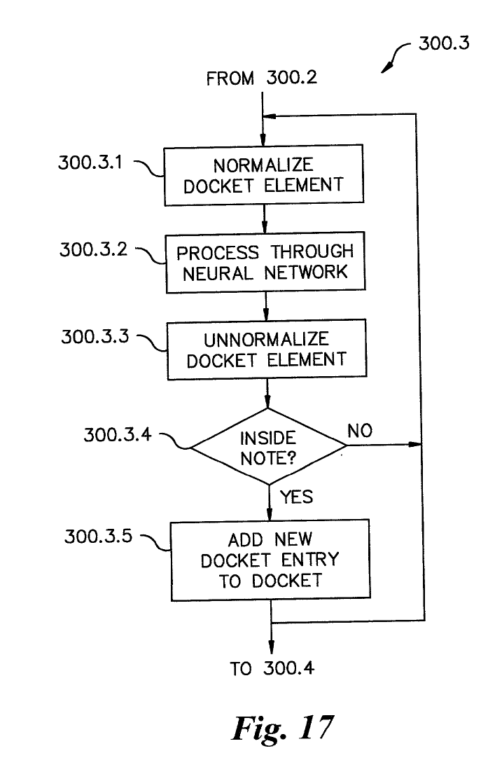

At step 300.3, shown at FIG. 17, a process is performed to determine the presence of a potential note having a fundamental frequency within the neighborhood of a lower frequency note. This process is also applicable to a span of harmonically related inside notes. The process comprises three major steps: (1) step 300.3.1—normalizing the docket entry element for each docket entry; (2) step 300.3.2—processing each docket entry with the neural network 38; and (3) step 300.3.3—unnormalizing each docket entry element provided at the output of the neural network 38.

Initially, each element contained in the input docket entry is normalized, according to:

$${p}_{n} = 2 \cdot \frac{p - min ( p )}{max ( p ) - min ( p )} - 1 , \qquad ( 26 )$$

where: pₙ is a normalized docket entry element value, p is an unnormalized docket entry element value, min(p) is the minimum value of each docket entry element for the set of docket entries that the neural network 38 has been trained on, and max(p) is the maximum value of each docket entry element for the set of docket entries that the neural network 38 has been trained on.

Following the normalization process, each of the twenty-four normalized elements in each docket entry is applied to each of six, first layer neurons of the neural network 38. Each of the elements is multiplied by a separate weight, W1 _{i, j}, where i=1 to 24 and j=1 to 6. The weighted inputs are then summed in the first layer neurons and a bias is added before applying the output of each first layer to a first transfer function, f, having a characteristic:

$$output = \frac{20}{( 1.0 + {ⅇ}^{- 2 \cdot input} )} - 1 \qquad ( 21 )$$

The six outputs of the six transfer functions f, are then multiplied by six additional weights W2_{2, j}. The weighted inputs are then summed in the second layer neuron and a bias is added before applying the result to a second transfer function, f, identical to the first transfer function.

In the first preferred embodiment, the values of the weighting functions W1 and W2, and the values of the bias are determined by training the neural network 38 using the method of Bayesian regularization, as described in Bayesian Interpolation, MacKay, D. J. C., vol. 4, number 3, Neural Computation, pp. 415-447, 1992, which is hereby incorporated by reference. In the first preferred embodiment, data used for training the neural network 38 is based on an excess of 1000 samples of polyphonic segments of music, where the samples are selected from a variety of musical instruments having a variety of voicings and chords. The training data is processed so as to place the data into the format of a docket entry prior to being applied to the neural network 38. One skilled in the art would recognize that other methods for training the neural network 38 are well known and could be used in place of the aforementioned method.

Values of the docket entry elements returned from the neural network 38 are then unnormalized by the following function:

p=0.5(n+1)·(max(p)−min(p))+min(p) (22)

where: p is the unnormalized value, pₙ is the normalized value and max(p), and min(p) are the same as in the normalizing function.

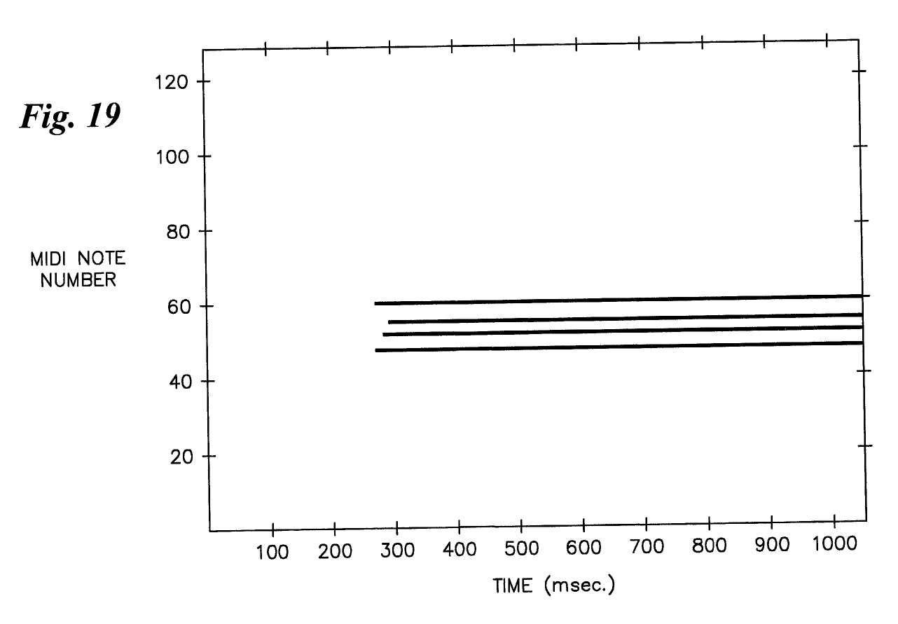

The output of the neural network 38, after unnormalizing, is the probability of there being a note in the neighborhood of a given harmonic, expressed as a value between 0 and 1. If an inside note is determined to exist by having a probability greater than a predetermined value (step 300.3.4), a new docket entry, having the detected fundamental frequency is added to the list of docket entries (step 300.3.5). FIG. 19 is a frequency domain depiction of the tracks of FIG. 2 showing the final determination of the start time, stop time and fundamental frequencies of notes comprising the four note chord after processing of the docket by the neural network 38.

At step 400 (see FIG. 4), an event list (see Table II) is created from each docket entry existing after processing of the docket by the neural network 38. Each entry in the event list includes an event type (note on or note off); start time; frequency (MIDI pitch); time duration; and amplitude (MIDI velocity). The duration of an event is determined by the length of the longest track in the centroid member list.

TABLE II

| Timestamp (ms) | Event type | MIDI pitch | MIDI velocity |
|---|---|---|---|
| Event 1 | on | | |
| Event 2 | off | | |
| . . . | | | |
| Event n | | | |

In the first preferred embodiment, the event list is applied to a MIDI engine (step 500), residing in the processor 20. The MIDI engine formats the note events in the event list according to the MIDI specification and provides the MIDI formatted data for the storage device 22, and/or for output via the output port 34, the modem 28, and the synthesizer/loudspeaker 26.

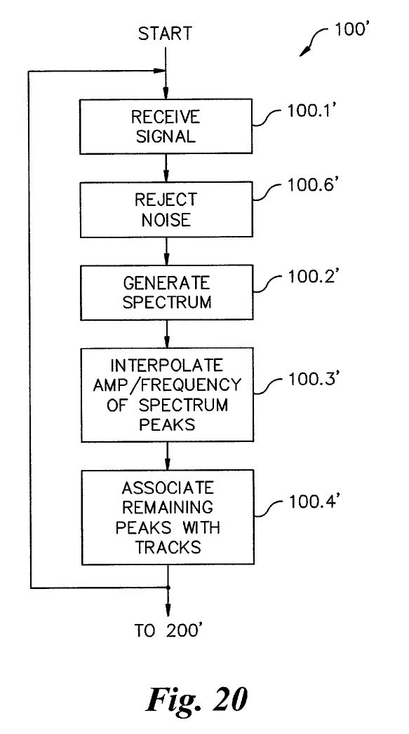

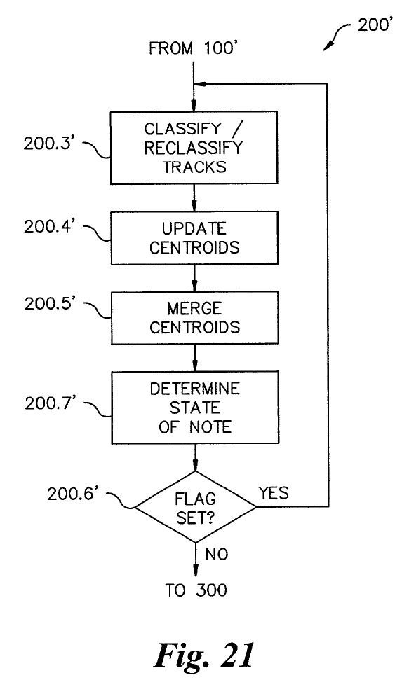

Referring now to FIGS. 20 and 21 there is shown a second preferred embodiment of the present invention. The second preferred embodiment differs from the first preferred embodiment by operating on a single buffer of the audio signal at a time in contrast to the first preferred embodiment, which operates on a plurality of buffers of the audio signal at a time. The processing performed by second preferred embodiment is identical to the processing of the first preferred embodiment except for the steps described below. Accordingly, the steps which are identical between the first and the second preferred embodiments are not described, for the sake of brevity.

Referring now to FIG. 20, (step 100′) there is introduced step 100.6′ for discarding each buffer of 1024 samples of audio signal that is determined to be noise like. Preferably, the decision on whether each buffer of the audio signal is noise-like is determined by computing the local fractal dimension of the audio signal, as described in U.S. Pat. No. 6,124,544, which is hereby incorporated by reference in its entirety. As will be appreciated by those skilled in the art, other methods may be used for determining whether the audio signal is noise-like, such as autocorrelation of the audio signal, and still be considered to be within the spirit and scope of the invention.

Following the discarding of noise-like audio signal, each buffer of the audio signal is subjected to an FFT at step 100.2′. Step 100.2′ is identical to step 100.2 except that each buffer of the audio signal is padded out to 2048 samples and the FFT is of a size 2048 points instead of a size of 8192 points. At step 100.3′, the spectral data is interpolated identically to step 100.3. At step 100.4′, a track is associated with each interpolated spectral peak. Each track is characterized with the frequency and the time of the associated peak eliminating the necessity for updating the track frequency or for iterating the track generating process 100′.

Referring now to FIG. 21, step 200′ is identical to step 200 except that steps 200.1 and 200.2 are not performed, the distance measure performed at step 200.3.9 is computed based on only the frequency of each track and the frequency of the corresponding centroid and an additional step (step 200.7′) is added.

At step 200.7′ the audio signal in each buffer is classified into one of three states: (1) an initial state, (2) a steady state and (3) a restruck state. The state of the audio signal in the current buffer is determined by comparing the frequency and amplitude associated with the centroid(s) of the current buffer with the frequency and amplitude of the centroid(s) associated with a previous buffer. If the difference between the frequency and the amplitude characterizing the audio signals in the two buffers falls within a predetermined value, the note represented by the centroid is determined to be in the steady state and the centroids of the two buffers are merged. If any centroids of the current buffer are newly instantiated, the note is determined to be new. If the difference between the frequency and amplitude of the two buffers is greater than the predetermined value, the note is determined to be a restrike.

Each centroid associated with the current buffer is then subjected to a fitness test to determine if: (1) the centroid contains at least 3 non-zero-magnitude tracks with total amplitude greater than a certain threshold, or (2) the centroid contains one track which is the fundamental having an amplitude greater than a predetermined threshold, or (3) the centroid contains two tracks that have a harmonic number difference less or equal to three, and a total amplitude greater than a predetermined threshold. If the centroid fails to meet one of the aforementioned criteria, the centroid is discarded.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A method for determining a fundamental frequency of a note in a musical signal, the method comprising the steps of:
receiving the musical signal;
determining a frequency of each of a plurality of tracks of the musical signal;
generating a plurality of subharmonics for each track; and
computing the fundamental frequency of the note based on a frequency of at least one subharmonic selected from the plurality of subharmonics, the frequency of the at least one selected subharmonic being within a neighborhood of the frequency of the track having the lowest track frequency.

2. A method according to claim 1, wherein the fundamental frequency is an average of the frequency of the track having the lowest frequency and the frequency of the at least one selected subharmonic.

3. A method according to claim 2, wherein the fundamental frequency is an average of the frequency of the at least one selected subharmonic nearest to the frequency of the track having the lowest frequency and the frequency of the track having the lowest frequency.

4. The method according to claim 1, wherein the frequency of each track is determined from a spectrum of the musical signal, the spectrum comprising a plurality of spectral peaks, each one of the plurality of spectral peaks meeting a predetermined criteria being associated with one and only one of a plurality of tracks.

5. The method of claim 4, wherein the spectrum is generated by taking a Fourier transform of the musical signal.

6. The method of claim 4, wherein each peak is associated with a track by a nearest neighbor rule.

7. The method of claim 6, wherein the nearest neighbor rule comprises the steps of:
determining a distance from each track to each peak based upon an amplitude and a frequency of each one of the plurality of peaks and an amplitude, rate of change of the amplitude, an instantaneous frequency and a rate of change of the instantaneous frequency of each track;
ranking each track in respect to each peak according to the distance between the respective track and the respective peak; and
associating each peak with one and only one of the plurality of tracks based upon the rank of the track.

8. The method of claim 7 wherein the distance is determined by a Kalman tracker.

9. The method of claim 7, wherein the distance is calculated by an alpha-beta filter.

10. The method of claim 1, further including the step of outputting an event list describing the sequence of notes in the musical signal, wherein each event in the event list is characterized by one of an on time and an off time, a MIDI pitch and a MIDI velocity.

11. A method for determining a fundamental frequency of a note in a musical signal, the method comprising the steps of:
receiving the musical signal;
determining a frequency of each of a plurality of tracks of the musical signal;
classifying each track to one and only one of a plurality of centroids, each centroid being characterized by a frequency;
updating the frequency of each one of the plurality of centroids based on an average of the frequency of each track classified to the respective centroid and a frequency of at least one subharmonic of each centroid for which the frequency of the subharmonic falls within a neighborhood of the respective centroid; and
merging the plurality of centroids such that a remaining centroid represents the fundamental frequency of the note.

12. The method according to claim 11, wherein the frequency of each track is determined from a spectrum of the musical signal, the spectrum comprising a plurality of spectral peaks, each one of the plurality of spectral peaks meeting a predetermined criteria being associated with one and only one of a plurality of tracks.

13. The method of claim 12, wherein the spectrum is generated by taking a Fourier transform of the signal.

14. The method of claim 12, wherein each peak is associated with a track by a nearest neighbor rule.

15. The method of claim 14, wherein the nearest neighbor rule comprises the steps of:
determining a distance from each track to each peak based upon an amplitude and a frequency of each one of the plurality of peaks and an amplitude, rate of change of the amplitude, an instantaneous frequency and a rate of change of the instantaneous frequency of each track;
ranking each track in respect to each peak according to the distance between the respective track and the respective peak; and
associating each one of the plurality of peaks with one of the plurality of tracks based upon the rank of the track.

16. The method of claim 15 wherein the distance is determined by a Kalman tracker.

17. The method of claim 15, wherein the distance is calculated by an alpha-beta filter.

18. The method according to claim 11, wherein the frequency of each centroid is computed based on an average of the frequency of the track having the lowest frequency and the frequency of the at least one subharmonic.

19. The method according to claim 18, wherein the frequency of each centroid is updated based on an average of the frequency of the at least one subharmonic nearest to the frequency of the track having the lowest frequency and the frequency of the track having the lowest frequency.

20. The method according to claim 11, wherein the plurality of centroids are merged based on a distance between a subharmonic of one of the plurality of centroids having a higher frequency and another one of the plurality of centroids having a lower frequency.

21. The method of claim 11, further including the step of outputting an event list describing the sequence of notes in the musical signal, wherein each event in the event list is characterized by one of an on time and an off time, a MIDI pitch and a MIDI velocity.

22. The method of claim 21, further including the step of detecting an inside note, wherein the inside note is added to the event list.

23. A method for detecting the presence of an inside note, the method comprising the steps of:
creating a list of a plurality of docket entries meeting a predetermined criteria, each docket entry representing a separate note;
applying each docket entry to a neural network, the neural network having been previously trained; and
outputting a signal for each docket entry proportional to a probability of the docket entry being a note having a fundamental frequency within a neighborhood of a harmonic of a different note.

24. The method of claim 23 wherein a docket entry comprises
a difference between a frequency of a track and a frequency of one of a plurality of harmonics of a fundamental frequency within a neighborhood of the track;
an amplitude of each one of the plurality of harmonics of the fundamental frequency;
a correlation of a frequency vector of the track and an amplitude vector of each of the plurality of harmonics; and
a correlation of the amplitude of the track and the amplitude vector of each of the plurality of harmonics.

25. The method of claim 23 wherein each docket entry that fails to meet the predetermined criteria is excised from the docket.

26. A computer readable medium having a computer executable program code stored thereon, the program code for determining at least one fundamental frequency of a musical signal, the program comprising;
code for receiving a musical signal;
code for determining a frequency of each of a plurality of tracks in the musical signal;
code for generating a plurality of subharmonics for each track; and
code for computing the at least one fundamental frequency based on at least one subharmonic selected from the plurality of subharmonics, a frequency of the at least one selected subharmonic being within a neighborhood of the frequency of the track having a lowest frequency.

27. The computer readable medium of claim 26, further including code for generating an event list describing a sequence of notes, each note corresponding to the at least one fundamental frequency.

28. A programmed computer for determining at least one fundamental frequency of a musical signal, the computer comprising:
an input device for receiving a musical signal and for converting the musical signal into a digital signal;
a storage device having a portion for storing computer executable program code;
a processor for receiving the digital signal and the computer program, wherein the computer program operates on the digital signal to determine a frequency of each of a plurality of tracks in the musical signal, to generate a plurality of subharmonics for each track, and to compute the at least one fundamental frequency based on a frequency of at least one subharmonic selected from the plurality of subharmonics and a frequency of the track having a lowest frequency; and
an output device for outputting the at least one fundamental frequency.
